(19) United States
(12) Patent Application Publication
(10) Pub. No.: US 2006/0085735 A1
(43) Pub. Date: Apr. 20, 2006

(54) Annotation management system, annotation managing method, document transformation server, document transformation program, and electronic document attachment program

(75) Inventor: Seiya Shimizu, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/290,658

(22) Filed: Dec. 1, 2005

Related U.S. Application Data
(63) Continuation of application No. PCT/JP03/11887, filed on Sep. 18, 2003.

(51) Int. Cl. G06F 15/00

(52) U.S. Cl. 715/512

(57) ABSTRACT

An annotation management system that manages annotation data of information regarding the annotation of an electronic document comprises: a client 4 having a browser 41 that conducts display of an electronic document, execution of an electronic document attachment program added to the electronic document and an acceptance of the user's input; a document server 2 that stores electronic documents; a database 5 that manages annotation data for every electronic document; and a document transformation server 3 that acquires a selected electronic document of the electronic document requested from the client 4 from the document server 2, generates a transformed electronic document which an electronic document attachment program that conducts input and display of the annotation data to the selected electronic document, and delivers the transformed electronic document to the client 4.

### TECHNICAL FIELD

The present invention relates to an annotation management system, an annotation managing method for managing an electronic document shared on a network or particularly managing an annotation which a plurality of users can input to and browse an HTML document on the Internet or intranet without altering the original HTML document. Then, the present invention further relates to a document transformation server, a document transformation program and an electronic document attachment program.

### BACKGROUND ART

Heretofore, there is an auxiliary software of a Web browser as a technology for putting a label on an HTML document on the Web. A label can be added to an HTML document on the Web by using this auxiliary software. It is possible to browse labels of the users. However, in this case, dedicated software is necessary to browse the labels. Moreover, a label only for a text can be used.

On the other hand, there is also a technology for attaching multimedia data on an HTML document as an annotation. In the HTML document, a URL of multimedia data as an annotation in an <A> tag is described on a part on which an annotation is put, such as a paragraph. Then, a link is set. Thereby, the multimedia data can be attached to the HTML document as an annotation. However, this accompanies the alteration of the original HTML document, which is not easy. It becomes difficult for a plurality of users to put an annotation on the HTML document.

In addition, heretofore, there is also a technology for managing an annotation to an electronic document by interpreting the context of a certain document. (For example, refer to Patent Document 1: Jpn. Pat. Appln. Laid-Open Publication No. 11-219245 (pages 5-7, FIG. 1))

According to this technology, a hand-written annotation is added to an electronic document and displayed, or the part including the annotation of the electronic document is highlighted and displayed. However, such a mechanism that displays information except the information displayed on the electronic document, that is shared by a plurality of users and that uses a general browser is not provided.

The present invention is made to solve the above-mentioned problems. An object of the present invention is to provide an annotation management system, an annotation managing method; a document transformation server, a document transformation program and an electronic document attachment program used for the system and the method that a plurality of users can add an annotation by a label and read a necessary annotation by using a general browser on a network without altering an original electronic document.

### DISCLOSURE OF THE INVENTION

The present invention is an annotation management system for managing annotation data of information regarding the annotation of an electronic document, comprising: a client having a browser that conducts display of an electronic document, execution of an electronic document attachment program added to the electronic document and an acceptance of a user's input; a document server that stores electronic documents; a database that manages annotation data for every electronic document; and a document transformation server that acquires a selected electronic document of the electronic document requested from the client from the document server, generates a transformed electronic document which an electronic document attachment program for conducting input and display of annotation data is attached to the selected electronic document, and delivers the transformed electronic document to the client.

According to such a configuration, a plurality of users can add and browse the annotation in the electronic document without altering the original electronic document.

Further, in the annotation management system according to the present invention, the annotation data includes an annotation content having a URL of a media file to become an annotation or a text to become an annotation, and a position for displaying a label based on the annotation data.

According to such a configuration, the media file or the text can be used as the annotation.

Moreover, in the annotation management system according to the present invention, the electronic document attachment program includes a document block specifying unit that divides the selected electronic document into document blocks so that a document block corresponding to the position specified by the user is set to the selected document block; an annotation data inputting unit that inputs input data regarding the annotation data; an annotation data generating unit that generates the annotation data corresponding to the selected document block based on the input data; an annotation data registering unit that registers the annotation data generated by the annotation data generating unit with the database; an annotation data acquiring unit that acquires the annotation data of the selected electronic document from the database; a label display unit that displays, in a duplicate manner, labels based on the annotation data acquired by the annotation data acquiring unit on the selected electronic document; and an annotation data display unit that displays the annotation data corresponding to the label specified by the user among the labels.

The user can input and browse the annotation by using a general browser by adding such an electronic document attachment program to the electronic document. Incidentally, the attachment program in this embodiment means the electronic document attachment program.

Further, in the annotation management system according to the present invention, the annotation content further contains a URL of a metafile describing a range that the media file is played back or information corresponding to the metafile when the type of the annotation content is a video media file or an audio media file.

According to such a configuration, only the necessary portion of the video or audio media file is played back, and can be thereby used as the annotation.

Furthermore, the annotation managing system according to the present invention further comprises a media server that manages the media file, and the electronic document attachment program further includes an upload unit that uploads the media file to the media server when the media file is not opened.

According to such a configuration, the electronic document attachment program performs uploading of the media file. Thus, the local media file can be easily used as the annotation.

Moreover, the annotation management system according to the present invention further comprises a media analysis server having: a document block dividing unit that divides the selected electronic document into document blocks; a keyword extracting unit that extracts a keyword contained in the document blocks; a document keyword appearance frequency detecting unit that detects the appearance frequency of the keyword in the document blocks; a media block dividing unit that divides the media file into media blocks; a voice recognizing unit that performs voice recognition of the keyword by using voice data in the media blocks; a media keyword appearance frequency detecting unit that detects the appearance frequency of the keyword in the media blocks; an association unit that associates the document blocks with the media blocks based on the appearance frequency of the keyword in the document blocks and the appearance frequency of the keyword in the media blocks; a metafile generating unit that generates a metafile describing the range of the media file played back corresponding to the selected document block; and an upload unit that uploads the metafile to the media server.

Further, the annotation management system according to the present invention further comprises a media analysis server having: a document block dividing unit that divides the selected electronic document into document blocks; a keyword extracting unit that extracts a keyword contained in the document blocks; a document keyword appearance frequency detecting unit that detects the appearance frequency of the keyword in the document blocks; a media block dividing unit that divides the media file into media blocks; a character recognizing unit that performs voice recognition of the keyword by using dynamic image data in the media blocks; a media keyword appearance frequency detecting unit that detects the appearance frequency of the keyword in the media blocks; an association unit that associates the document blocks to the media blocks based on the appearance frequency of the keyword in the document blocks and the appearance frequency of the keyword in the media blocks; a metafile generating unit that generates a metafile describing the range of the media file played back corresponding to the selected document block; and an upload unit that uploads the metafile to the media server.

According to such a configuration, the playback starting time and the playback ending time of the video or audio media file are not specified by the user, but only an adequate range can be used as an annotation.

Furthermore, in the annotation management system according to the present invention, the electronic document attachment program further includes a metafile generating unit that determines the range that the media file is played back according to the user's input to generate a metafile for playing back the range.

According to such a configuration, the user can freely specifies the range of the media file necessary for the annotation.

Moreover, in the annotation management system according to the present invention, the electronic document attachment program further includes a keyword extracting unit that extracts a keyword contained in the selected document block. Further, the annotation data further contains the keyword.

According to such a configuration, at the annotation data browsing time, retrieving or filtering can be conducted by using the keyword.

Further, in the annotation management system according to the present invention, the document transformation unit adds a tag representing the delimiter of the document blocks according to a predetermined rule to the transformed electronic document.

According to such a configuration, the size of the document block can be adjusted, and the number of keywords in the document blocks can be regulated.

Furthermore, in the annotation management system according to the present invention, the annotation data further contains an annotator name and an annotation ID. When the annotator name or the annotation ID is specified, the annotation data acquiring unit acquires only the annotation data in which the specified annotator name or the annotation ID coincides.

According to such a configuration, an annotation in an HTML document can be specified on an annotator name basis and an annotation basis by representation using a URL. Further, this URL can be notified to the other user via an e-mail.

The present invention is a document transformation server that acquires an electronic document stored in the server on a network, transforms the document and delivers the document to a client in the network. The document transformation server includes a selected electronic document acquiring unit that acquires a selected electronic document of the electronic document requested from the client from a document server, a transformed electronic document generating unit that generates a transformed electronic document which the electronic document attachment program for inputting and displaying annotation data is attached to the selected electronic document, and a transformed electronic document delivering unit that delivers the transformed electronic document to the client.

According to such a configuration, a plurality of the clients can easily input or display the annotation data on the electronic document without altering the original electronic document. Incidentally, the document acquiring unit 31 in this embodiment means a selected electronic document acquiring unit. The document transformation unit 32 means a transformed electronic document generating unit and a transformed electronic document delivering unit.

Moreover, in the document transformation server according to the present invention, the electronic document attachment program includes: a document block specifying unit that divides the selected electronic document into document blocks so that a document block corresponding to the position specified by the user is set to the selected document block; an annotation data input unit that inputs input data regarding the annotation data;, an annotation data generating unit that generates the annotation data corresponding to the selected document block based on the input data; an annotation data registering unit that registers the annotation data generated by the annotation data generating unit with the database; an annotation data acquiring unit that acquires the annotation data of the selected electronic document from the database; a label display unit that displays, in a duplicate manner, labels based on the annotation data acquired by the annotation data acquiring unit on the selected electronic document; and an annotation data display unit that displays the annotation data corresponding to a label specified by the user among the labels.

The user can input and browse the annotation by using a general browser by adding such an electronic document attachment program to the electronic document.

Further, the present invention is an annotation managing method that manages annotation data of information regarding the annotation of an electronic document, comprising: storing the electronic document; managing annotation data for every electronic document; acquiring the selected electronic document of the electronic document requested from the browser from a document server; generating the transformed electronic document which the electronic document attachment program for inputting and displaying annotation data is attached to the selected electronic document; conducting display of the transformed electronic document, execution of the electronic document attachment program attached to the transformed electronic document and receiving inputs of the user; generating annotation data according to the user's input; and registering the annotation data.

Furthermore, the present invention is an electronic document attachment program that is attached to the selected electronic document selected by the user and stored in a computer-readable medium in order to make a computer execute an electronic document attachment method for performing input and browse of the annotation data. The electronic document attachment program makes a computer execute the steps of: dividing the selected electronic document into document blocks and making a document block corresponding to the position specified by the user as the selected document block; inputting input data regarding the annotation data; generating the annotation data corresponding to the selected document block based on the input data; registering the generated annotation data with the database; acquiring the annotation data of the selected electronic document from the database; displaying, in a duplicate manner, labels based on the annotation data on the selected electronic document; and displaying the annotation data corresponding to a label specified by the user among the labels.

The present invention is a document transformation program stored in a computer-readable medium in order to make a computer execute a document transformation method that acquires and transforms an electronic document stored in a server on a network and delivers the document to the client on the network. The program makes a computer execute the steps of: acquiring the selected electronic document of the electronic document requested from the client; generating the transformed electronic document which the above electronic document attachment program is attached to the selected electronic document; and delivering the transformed electronic document to the client.

Incidentally, in the above electronic document attachment program and the document transformation program, the computer-readable medium includes, in addition to a semiconductor memory such as a ROM, a RAM, a portable storage medium such as a CD-ROM, a flexible disk, a DVD disk, a magneto-optic disk, an IC card, a database for holding a computer program, or other computers as well as its database, further a transmission medium on a line.

### BRIEF DESCRIPTION OF THE DRAWINGS

FIG. 1 is a block diagram showing an example of a configuration of an annotation attachment program in this embodiment;

FIG. 2 is a flowchart showing an example of an operation of a browser in an annotation attachment system;

FIG. 3 is a view showing an example of a user log-in screen;

FIG. 4 is a view showing a display example of a transformed HTML document in a browser;

FIG. 5 is a view showing a display example of a label;

FIG. 6 is a view showing a display example of an annotation input dialog when a type of the annotation is a text;

FIG. 7 is a view showing a display example of a label display dialog when the type of the annotation is a text;

FIG. 8 is a source showing an example of a selected HTML document;

FIG. 9 is a source showing an example of a transformed HTML document;

FIG. 10 is a source showing an example of an HTML element displaying a label;

FIG. 11 is a source showing an example of the selected HTML document before <SPAN> tag is inserted;

FIG. 12 is a source showing an example of the selected HTML document after <SPAN> tag is inserted;

FIG. 13 is a source showing an example of annotation data when the type of the annotation is a text;

FIG. 14 is a source showing an example of management data for every HTML document;

FIG. 15 is a source showing an example of the annotation data when the type of the annotation is static media;

FIG. 16 is a source showing an example of a metafile when an ASX is used;

FIG. 17 is a source showing an example of the annotation data when the type of the annotation is a continuous media;

FIG. 18 is a flowchart showing an example of an operation of a media analysis process in the media analysis server;

FIG. 19 is a view showing the relationship between the document block and the media block; and

FIG. 20 is a source showing an example of the transformed HTML document attached by the specification of an annotator name and an annotation ID.

### BEST MODE FOR CARRYING OUT THE INVENTION

Hereinafter, embodiments of the present invention will be described in detail with reference to the drawings.

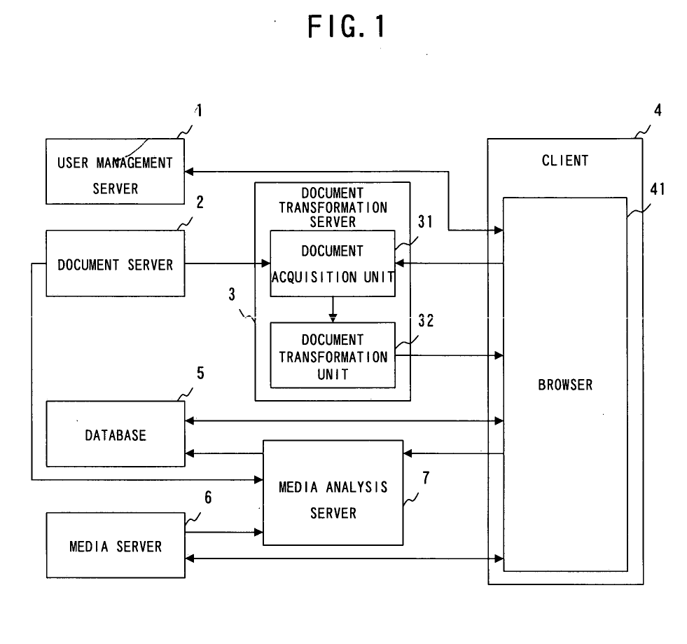

First, the configuration of the annotation management system according to the embodiment will be described by using FIG. 1. As shown in FIG. 1, the annotation management system comprises a user management server 1, a document server 2, a document transformation sever 3, a client 4, a database 5, a media server 6, and a media analysis server 7.

The document transformation server 3 includes a document acquisition unit 31 and a document transformation unit 32. The client 4 is, for example, a PC (Personal Computer), and has a browser 41. In this embodiment, an HTML document is used as an example of the electronic document, and will be described. The browser 41 can read the HTML document and is a general Web browser which can execute Java Script.

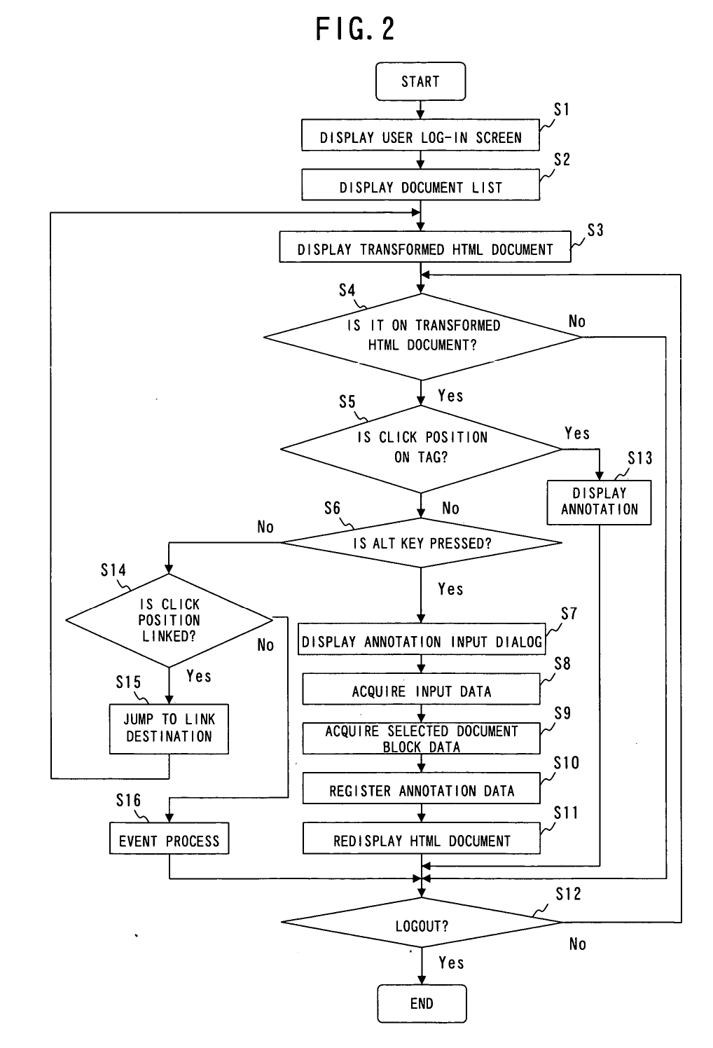

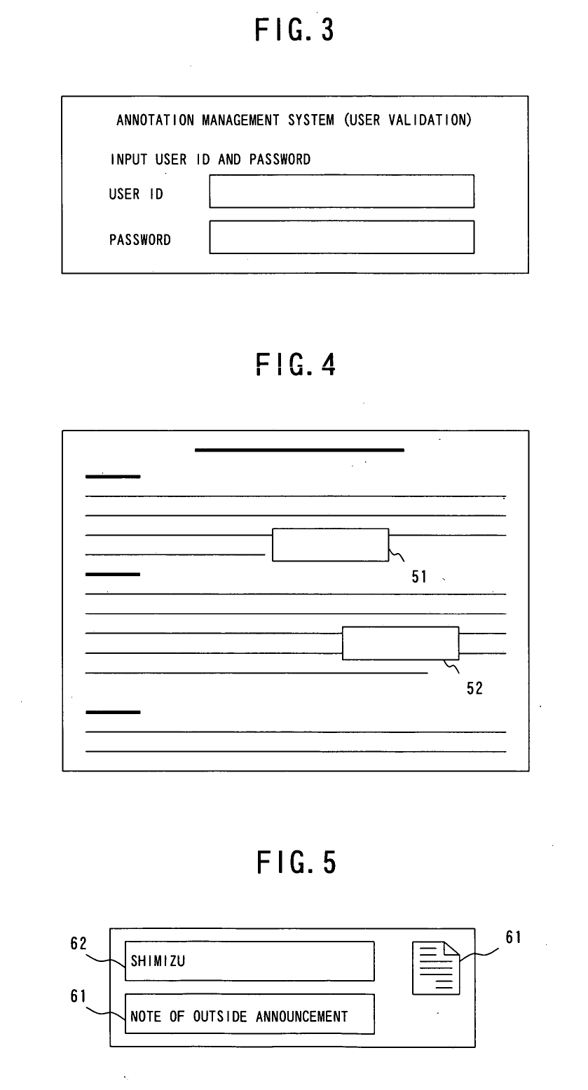

Then, the general operation of the annotation management system according to the embodiment will be described according to the operation of the browser. FIG. 2 is a flowchart showing an example of the operation of the browser in the annotation management system. First, when a user accesses the user management server 1 by using the browser 41, the browser 41 displays a user log-in screen shown in FIG. 3 (S1). When the user inputs a user ID and a password, the browser 41 transmits the user ID and the password to the user management server 1. The user management server 1 manages the user with the ID and the password, and also manages the domain or the HTML document of the document server 2 accessible by the user to refuse the access to document which the user has no right to access. The user management server 1 authenticates the user and accordingly, the browser 41 assures the right to access the annotation management system.

Subsequently, the user management server 1 transmits an accessible document list to the client 4. Then, the browser 41 displays the document list (S2). Here, the document list contains a link for accessing to the HTML document by the user. The link to each HTML document does not link directly to the document sever 2 which stores the HTML document, but accesses to the document transformation server 3. The link is displayed in the form that the URL of the HTML document in the document server 2 is delivered to the document transformation server 3. Then, the user selects an HTML document that the user wants to browse from the document list on the browser 41, and the browser 41 delivers the URL of the selected HTML document to the document transformation server 3. Hereinafter, the selected HTML document is called a selected HTML document. Here, the document list may be on other server. A link that the user accesses the HTML document may be provided by an e-mail, or the like other than the HTML document.

The document acquisition unit 31 acquires the selected HTML from the document server 2. Then, the document transformation unit 32 performs a document transformation process on the acquired selected HTML to generate a transformed HTML document. The document transformation unit 32 then transmits the transformed document to the client 4. The document transformation process is a process to attach an attachment program for displaying and inputting an annotation to the selected HTML and a tag for displaying the label. This document transformation process will be described in detail later. Here, only the document delivered from the document transformation server 3 to the client 4 is transformed, but the original document stored in the document server 2 is not altered.

Subsequently, the browser 41 displays the transformed HTML document (S3). Here, in the case where the selected HTML document is displayed on the browser and the case where the transformed HTML document is displayed on the browser, the texts on the browsers are apparently the same. At this time, the browser 41 retrieves the database 5 according to the attachment program in the transformed HTML document. Then, the browser 41 acquires the annotation data regarding the selected HTML document to display in an overlaid manner as a label on the corresponding document block in the transformed HTML document. FIG. 4 is a view showing an outline of the screen displaying the transformed HTML document. Here, an example, which labels 51 and 52 are already adhered to the transformed HTML document, is shown.

FIG. 5 is a view showing a display example of a label. As shown in FIG. 5, an annotation title 61, an annotator name 62, and an icon 63 showing an annotation type are displayed on the labels. The annotation type includes a text, an image, a video, an audio, etc. A static media, a video, an audio of the image are defined as continuous media. The example of FIG. 5 shows the case where the annotation type is a text.

The user clicks the position where the user wants to adhere the label when the annotation input is desired, and clicks the label that the user wants to browse when the annotation display is desired. In the embodiment, to distinguish the click for inputting the annotation from a click for processing an event by a jump to a link destination on the transformed HTML document or Java Script, etc., the click for inputting the annotation is conducted while pressing the ALT key.

Then, the browser 41 judges whether the user clicks on the transformed HTML document (S4). When the user does not click on the document (No in S4), the browser 41 shifts to a process S12. When the user clicks on the document (Yes in S4), the browser 41 judges whether the clicking position is a label or not (S5).

When the user's clicking position is not a label (No in S5), the browser 41 judges whether the ALT key is pressed together with the clicking (S6). When the user merely clicks (No in S6), if the clicking position is a link (Yes in S14), the browser 41 jumps to a link destination (S15) and shifts to a process S3. Moreover, if the clicking position is not a link (No in S14), the browser 41 performs an event process according to the clicking position (S16) and shifts to a process S12.

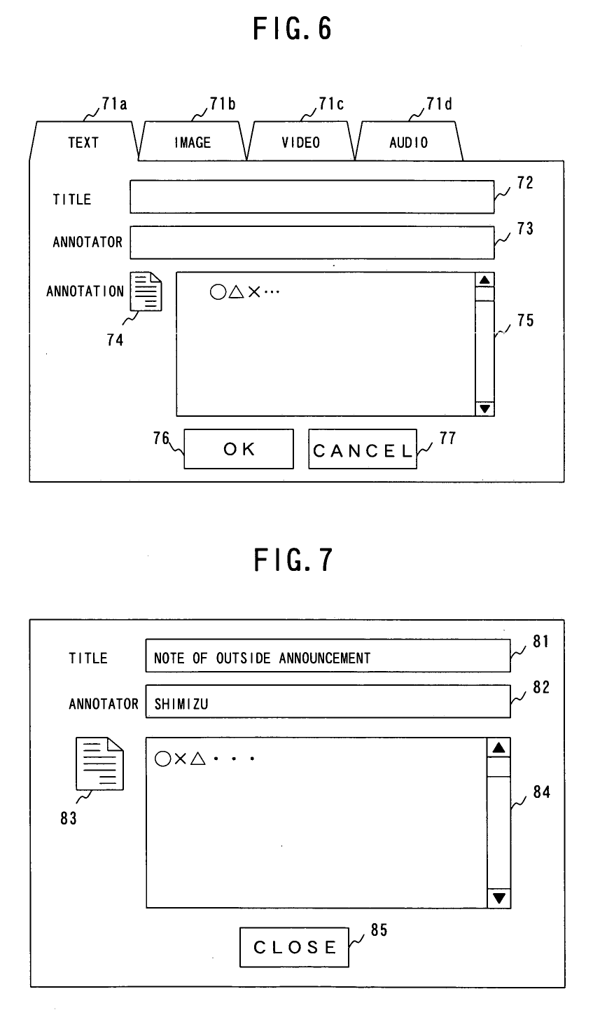

On the other hand, when the ALT key is pressed together with the clicking (Yes in S6), the browser 41 displays an annotation input dialog according to the attachment program (S7). FIG. 6 is a view showing an example of the annotation input dialog. As shown in FIG. 6, the annotation input dialog includes a text tab 71a, an image tab 71b, a video tab 71c, and an audio tab 71d. When the user selects one tab, an annotation title input column 72, an annotator input column 73, an icon 74 for displaying an annotation type, an annotation content input column 75, an OK button 76 for performing the registration of an annotation, and a cancel button 77 for interrupting the registration of the annotation. Here, in the annotation input dialog, the color of the label and the color of the character in the label may be specified.

FIG. 6 shows an example of the annotation input dialog when the user selects the text tab. When the user selects the text tab 71a, the annotation content that the user inputs in the annotation content input column 75 is a text.

In FIG. 6, when the user selects the image tab 71b, the annotation content inputted by the user in the annotation content input column 75 is a URL storing a static media. Further, the annotation content input column 75 displays a static media corresponding to the annotation content.

In FIG. 6, when the user selects the video tab 71c or the audio tab 71d, the annotation content inputted by the user in the annotation content input column 75 includes a URL storing the continuous media and a segment displaying the range used for the annotation in the continuous media. The segment includes, for example, a playback starting time and a playback ending time in the continuous media. Further, the annotation content input column 75 plays back a continuous media corresponding to the annotation content.

When the user selects the type of the annotation by the tab, an annotation title, annotator name and annotation contents are inputted. When the OK button 76 is clicked, the browser 41 acquires information of an annotator name, an annotation date, an annotation title, an annotation content, a clicking position, etc., according to the attachment program as input data (S8). Then, the selected document is divided into document blocks by a predetermined dividing method. A document block corresponding to the clicking position in the document is made as the selected document block. A selected document block data acquisition process for acquiring the information extracted from this selected document block as the selected document block data is performed (S9). Then, the annotation data is generated from the input data and the selected document block data. Then, an annotation data registering process for registering with the database 5 is performed (S10). The details of the selected document block data acquisition process and the annotation data registering process will be described later. Then, the browser 41 performs a redisplay of the transformed HTML document according to the attachment program. Thereby, the browser 41 reads the annotation data newly registered, displays the annotation data on the transformed HTML document as a label (S11), and shifts to the process S12.

Moreover, when the clicking position is the label (Yes in S5), the browser 41 displays the annotation data of the clicked label according to the attachment program (S13). Then, the browser 41 shifts to the process S12. Here, when the annotation type is a text, the browser 41 displays the text of the annotation content. When the annotation type is an image, the browser 41 displays the image of the annotation content. When the annotation type is a video, the browser 41 plays back the video of the annotation content, and displays a control necessary to playback the video. When the annotation type is an audio, the browser 41 plays back the audio of the annotation content, and displays a control necessary for the playback. FIG. 7 is a view showing an example of a label display dialog when the annotation type is a text. As shown in FIG. 7, the label display dialog displays a title 81, an annotator 82, an icon 83 for displaying an annotation type, an annotation content 84, and a CLOSE button 85 for closing the label display dialog. In the example shown in FIG. 7, a text is displayed as the annotation content 84.

Here, when the annotation type is a static media, the static media is displayed on the annotation content 84. Further, when the annotation type is a video, the video, a playback button, and the like are displayed in the annotation content 84. The annotation content 84 is controlled by the user. Furthermore, when the annotation type is an audio, the annotation content 84 displays the playback button, and the like and the annotation content is controlled by the user.

When the user does not want to log out after the annotation input, annotation display or an event process (No in S12), the browser 41 returns to the process S4. When the user wants to log out (Yes in S12), this flow is ended. According to the operation of the above-mentioned annotation management system, the user can input or browse the annotation regarding the HTML document by using the general browser 41.

The document transformation process will be described in detail. Here, in the document server 2, a URL storing the selected HTML document is a URL-A (for example, http://www.html-server-2.com/html-doc-D1.html), a URL described in a document list to actually access the selected HTML document is a URL-B (for example, http://www.trans-server-3.com/trans.cgi?url=http://www.html-server-2.com/ht ml-doc-D1.html). Here, “www.html-server-2.com” is the URL of the document server 2, “www.trans-server-3.com” is the URL of the document transformation server 3, and trans.cgi is a CGI (Common Gateway Interface) program operating in the document transformation server 3. The URL-B shows that the URL-A is delivered as an argument to the CGI program.

The CGI program of the document transformation server 3 is constituted by the document acquisition unit 31 and the document transformation unit 32. First, the accessed document acquisition unit 31 separates the URL-A from the URL-B, and acquires the selected HTML document corresponding to the URL-A from the document server 2. Then, the document transformation unit 32 attaches an attachment program to the selected HTML document. The document transformation unit 32 adds a <DIV> tag for adhering a label to the HTML document to generate a transformed HTML document. In this embodiment, the case where the attachment program is packaged by Java Script, will be described.

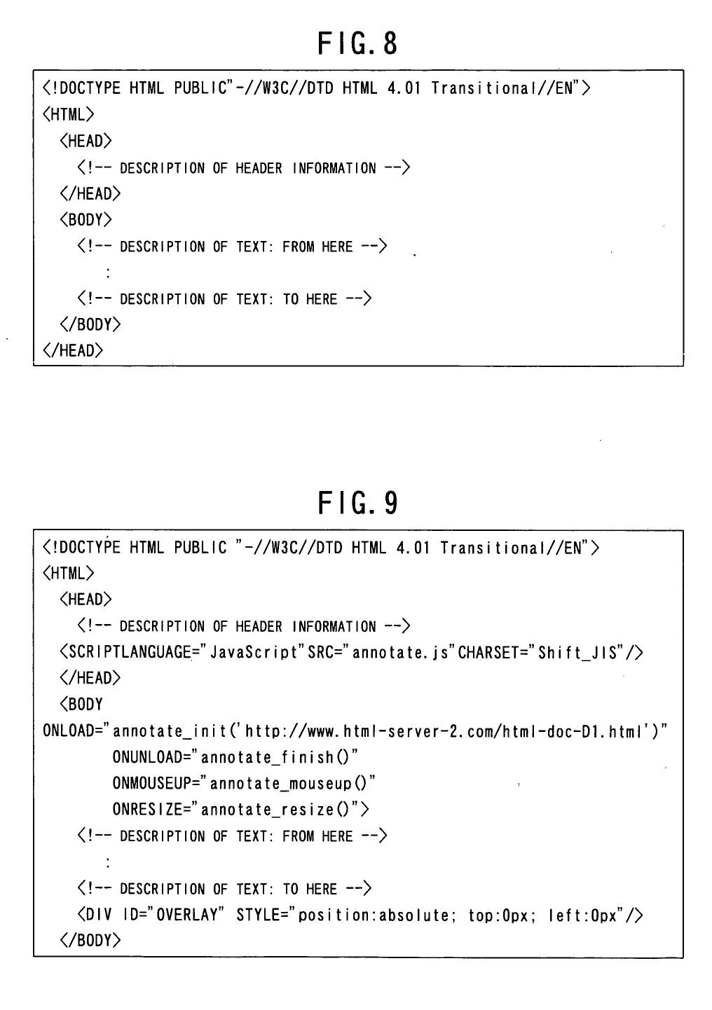

FIG. 8 shows a source of the selected HTML document. FIG. 9 shows a source of the transformed HTML document. In the example of FIG. 9, the added attachment program exists as another file. The attachment program is specified as “annotate.js” in the transformed HTML document. The function started with the “annotate” defined as an event handler of a <BODY> tag is packaged in the “annotate.js”. Further, <DIV ID=“OVERLAY”> is a <DIV> tag added to display the label and is laid out with the displaying origin of the transformed HTML document as an origin according to a STYLE attribute. As the slave of this <DIV>, an HTML element regarding the label display is added, and hence the label display is realized.

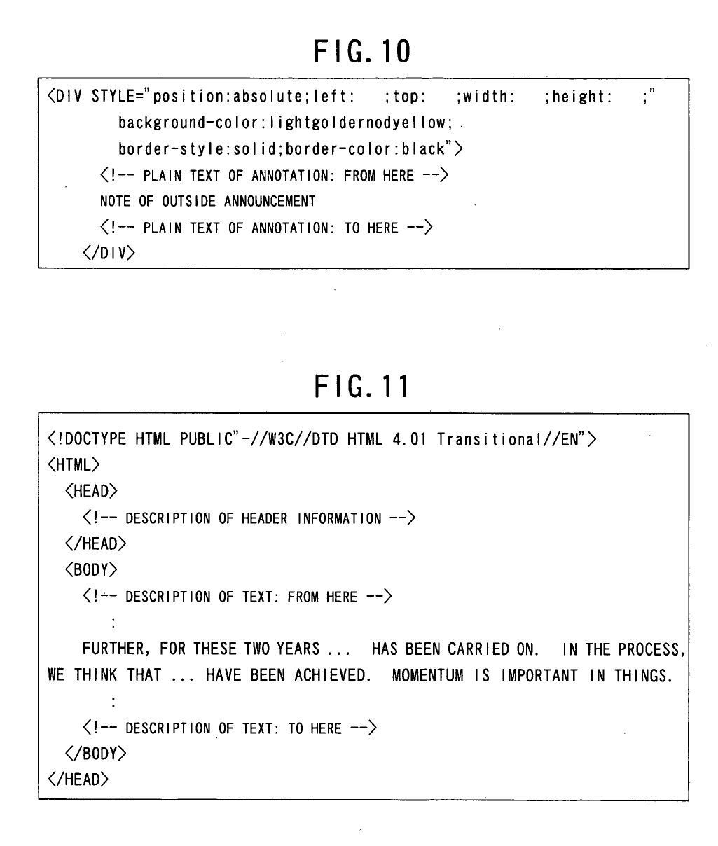

When the browser 41 reads the transformed HTML document from the document transformation server 3, the document is developed into an HTML DOM (Document Object Model), internally managed, and Java Script process system in the Web browser executes the attachment program. The attachment program delivers the URL-A to the database 5 when started. Accordingly, the browser 41 acquires the annotation data regarding the selected HTML document. Then, the browser 41 transforms the annotation data into an HTML element, and adds the HTML element as the slave node of the <DIV ID=“OVERLAY”> tag to the DOM. For example, to display only the annotation title “note of the outside announcement” of the annotation data as a label, the HTML element shown in FIG. 10 is added.

The display position of the label is specified by the left, top in the STYLE attribute. This position is obtained by calculation based on the position of the document block corresponding to the annotation. The size of the label is specified by a width and a height. This is obtained by calculating according to the displayed annotation title. The above description is the detail of the document transformation process.

Then, the selected document block data acquisition process will be described in detail. When the user clicks the position where a label is not present on the transformed HTML document, the browser 41 senses the click event and starts an annotation registering process from the event handler (annotate_mouseup( )function in FIG. 9) in the attachment program. Then, the attachment program divides the selected document into document blocks by a predetermined dividing method and specifies the selected document block of the document block corresponding to the clicked position. Then, the attachment program extracts information, such as a path, a keyword, a label position offset, etc., from the selected document block. As a unit of the document block, the paragraph shown by the <P> tag of the HTML, the document delimited by <BR>, etc., are used.

Here, the path shows a route reaching the selected document block with the <HTML> tag as a route on the DOM tree. Further, the path may be expressed by a child sequence number. For example, the path of “2/3/4” is the path expression for searching the second slave node at the <HTML> tag as a starting point, searching the third slave element of the slave node, and specifying the fourth slave element. The keyword is a characteristic pronoun included in the selected document block, and is obtained by a morphological analysis, etc. At the browsing time, the keyword is used for retrieving or filtering. The label position offset is the offset value of two-dimensional coordinates, expressing the position for displaying the label at the display origin of the selected document block as a starting point. The foregoing description is the detail of the selected document block data acquisition process.

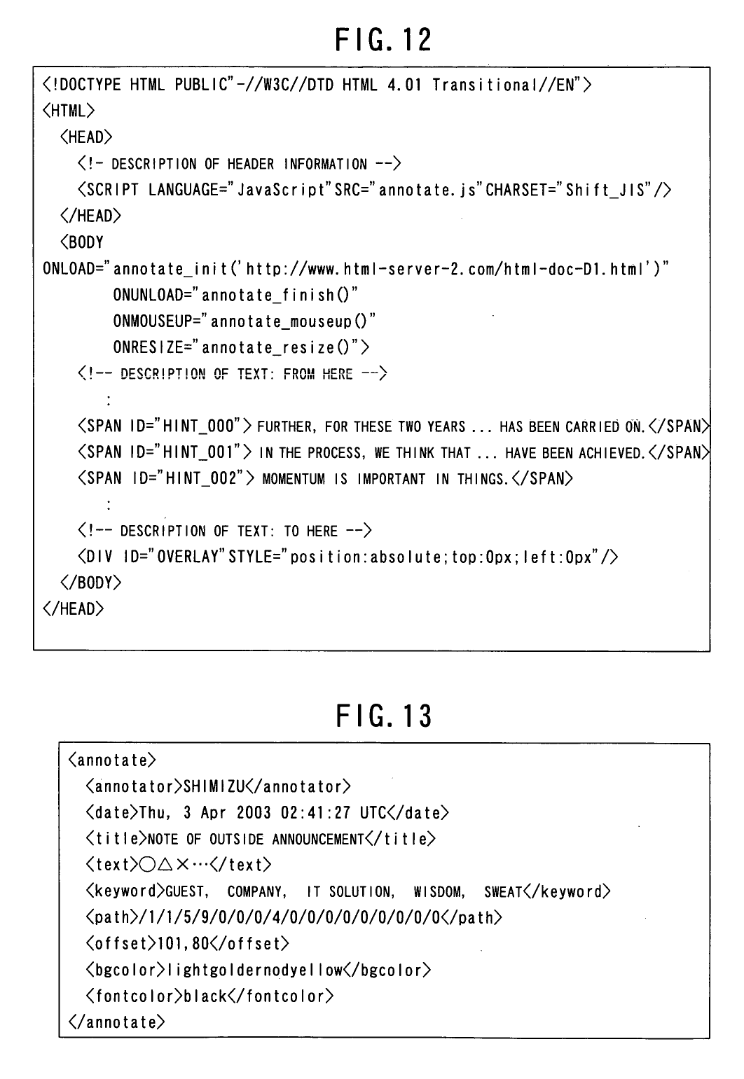

Moreover, the case where the <P> tag or the <BR> tag is not inserted with a suitable length into the selected HTML document, exists frequently. In this case, the words included in the keyword of the annotation data become plural. Thus, it might become the case where the annotation data cannot be gathered up by the retrieval. To solve this problem, when the document transformation server 3 generates a transformed HTML document, the document transformation server 3 may have the function of inserting the <SPAN> tag for every document block of arbitrary delimiter. The <SPAN> tag is attached with an intrinsic prefix as an ID such as, for example, “HINT_*”. For example, “o” in the selected HTML document is detected as the delimiter of the document block. FIG. 11 is a source showing an example of the selected HTML document before the <SPAN> tag is inserted. FIG. 12 is a source showing an example of the selected HTML document after the <SPAN> tag is inserted.

When the ID of the HTML DOM element of the selected document block is this prefix, the attachment program uses only the text in the <SPAN> tag as the object to extract the keyword. However, a hierarchy becomes one stage deeper by the <SPAN> regarding the path and the label position offset. Accordingly, the value in which the master element of the <SPAN> is used as a reference, is used. Thus, the keyword which reflects the user's intention more can be extracted.

Then, the annotation data registering process will be described in detail. First, the attachment program generates annotation data using the input data and the selected document block data. FIG. 13 shows an example of the annotation data when the annotation type is the text. The annotation data is, as shown in FIG. 13, described as follows. The annotator name is described by an <annotator> tag. The annotation date is described by a <date> tag. The annotation title is described by a <title> tag. The keyword is described by a <keyword> tag. The path is described by a <path> tag. The label position offset is described by an <offset> tag. Further, when the annotation type is a text, the text inputted by the user as the annotation content is represented by a <text> tag.

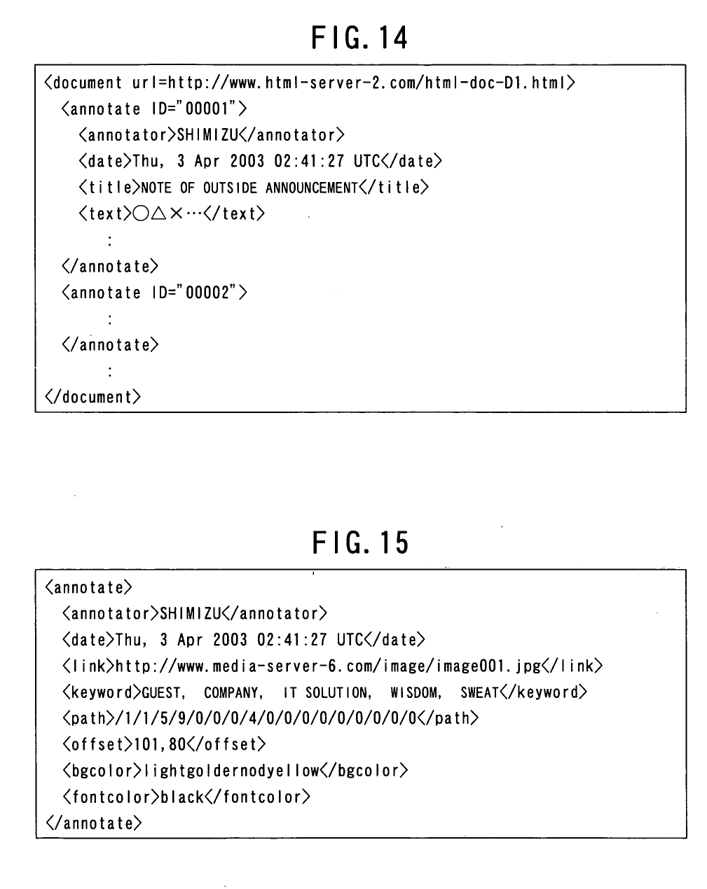

Subsequently, the attachment program registers the generated annotation data with the database 5. The database 5 is, for example, an RDB (Relational Data Base) which handles the XML or an ODB (Object Data Base). The database 5 gathers the annotation data for every HTML document, and manages the annotation data as management data. FIG. 14 shows an example of management data for every HTML document.

Incidentally, ID attribute is added to the <annotate> tag. However, this is the annotation ID which is uniquely given to manage the annotation data by the database 5.

Then, the annotation data registering process when the annotation type is static media, will be described in detail. When the media file of the static media specified by the user is a local file in the client 4, the attachment program uploads the media file to the media server 6. Thus, the attachment program acquires the URL of the corresponding media file on the media server 6. On the other hand, when the media file of the static media specifeid by the user is already stored in the server on the network, the URL which stores the corresponding media file is acquired. The annotation content becomes the URL of the acquired media file.

FIG. 15 shows an example of the annotation data when the annotation type is the static media. The annotation data shown in FIG. 15 has almost the same configuration as the annotation data in which the annotation type is a text. However, it is different at the point that, instead of describing the text with the <text> tag, the URL of the media file is described by the <link> tag. The foregoing description is the detail of the annotation data registering process when the annotation type is the static media.

The annotation registering process when the annotation type is continuous media will be described in detail. First, when the media file of the continuous media specified by the user is the local file on the client 4, similarly to the static media, the attachment program uploads the corresponding medial file to the media server 6, and the attachment program acquires the URL of the corresponding media file on the media server 6. On the other hand, when the media file of the continuous media specified by the user is already stored in the server on the network, the URL storing the corresponding media file is acquired. Further, the segment specification for specifying the range used to annotate in the continuous media includes a manual segment specification by the user's input, and an automatic segment specification by the media analysis server 7.

Here, the manual segment specification will be described. When the user selects the manual segment specification, the user inputs numeric values of the playback starting time and the playback ending time of the segment on the annotation input dialog, or inputs by GUI the playback starting position and the playback ending position while playing back the continuous media on the annotation input dialog. When the segment is specified, the attachment program forms the metafile of playing back the segment, and uploads to the media server 6. As the metafile, an ASX (Advanced Stream Redirector) and an SMIL (Synchronized Multimedia Integrated Language) can be used.

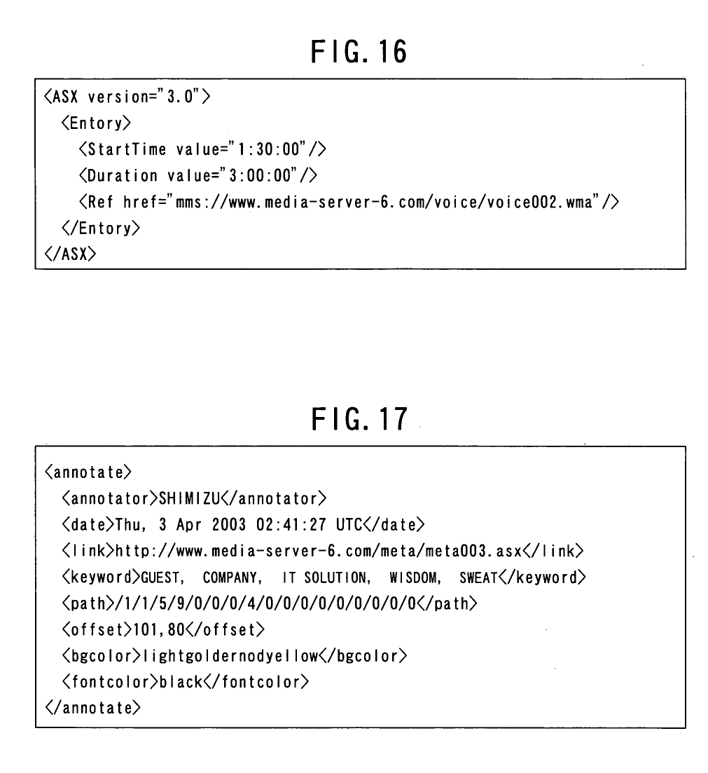

FIG. 16 shows an example of the metafile when the ASX is used. In the metafile “meta003.asx” shown in FIG. 16, the HREF attribute of the <Ref> tag is the URL for accessing the continuous media “voice002.wma” on the media server 6 by streaming. The VALUE attributes of the <Start Time> and the <Duration> show the playback starting time and the playback time (playback ending time-playback starting time) of the segment.

Then, the attachment program acquires the URL of the metafile uploaded to the media server 6, and generates annotation data. FIG. 17 shows an example of the annotation data when the annotation type is continuous media. The annotation data shown in FIG. 17 has almost the same configuration as the annotation data of the static media. However, the URL described by the <link> tag is different at the point that it is not the static media but the metafile. In FIG. 17, the URL of the metafile “meta003.asx” shown in FIG. 16 is used.

The foregoing description is the annotation data registering process when the manual segment specification is used. Incidentally, in the above-mentioned example, the metafile is prepared in addition to the annotation data. However, it is obvious that the information stored in the metafile is included in the annotation data and when the annotation is displayed, the browse information corresponding to the metafile may be automatically generated.

Then, the automatic segment specification will be described. When the user selects the automatic segment specification, the attachment program notifies the URL of the selected HTML document and the URL of the media file used for the selected document block and the annotation to the media analysis server 7. Then, the media analysis server 7 acquires the selected HTML document and the continuous media file. The media analysis server 7 determines the segment corresponding to the selected document block by the media analysis process.

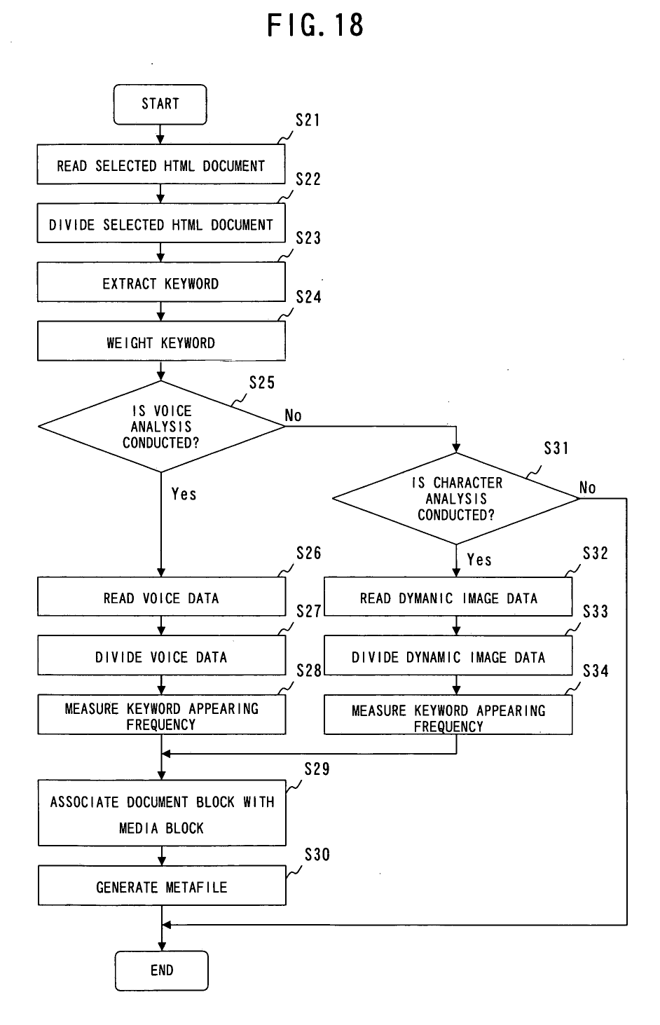

Here, the media analysis process in the media analysis server 7 will be described. FIG. 18 is a flowchart showing an example of the operation of the media analysis process in the media analysis server. First, the media analysis server 7 reads the selected HTML document (S21). Then, the selected HTML document is divided into a plurality of document blocks bₙ (n=1, 2, . . . , N) by a predetermined dividing method (S22). Then, the keyword set Θₙ for every document block bₙ is extracted by a morphological analysis (S23). Then, the appearance frequency of the keyword set Θₙ for every document block bₙ is obtained. Accordingly, an index representing the accuracy in the case where the sentence including a certain keyword θ(θ ε Θₙ) belongs to the document block bₙ is obtained and the index is set to the weighting W_{n,θ} of the keyword (S24). Then, it is determined whether the voice analysis is conducted to the continuous media (S25).

In the case where the voice analysis is conducted (Yes in S25), the media analysis server 7 reads the voice data in the continuous media (S26). Then, the media analysis server 7 detects a no-sound section in the voice data, and divides the section into K pieces of continuous sound section partitioned by the no-sound section to obtain a media block vₖ (S27). Then, regarding each media block, the presence or absence of the speech of the keyword is detected by the voice recognition process, such as word spotting. In the media block vₖ, the frequency that the keyword θ (θ □ Θₙ) in the document block bₙ appears is obtained to attain a keyword appearance frequency β_{k, n, θ} (S28), and the server 7 shifts to a process S29.

On the other hand, when the voice analysis is not conducted (No in S25), the media analysis server 7 judges whether the character analysis is conducted to the continuous media (S31). When the character analysis is conducted (Yes in S31), the media analysis server 7 reads dynamic image data in the continuous media (S32), and divides the dynamic image data into K pieces of scenes to obtain a media block vₖ (S33). Here, the division into the scenes may be achieved by dividing the dynamic image data at every predetermined time from the beginning, for example, at each 5 second, or may be achieved by detecting the turning point of the scene by using the existing scene change detecting technology. As the simple mounting of the scene change detection, there is, for example, a method for comparing adjustment frame images and obtaining the absolute value sum of the difference of the luminance value of each pixel and dividing the scene when the sum exceeds the threshold value.

Then, the character recognition is performed by using a telop or subtitles appearing on each media block, and the presence or absence of the character of the keyword is detected. The frequency that the keyword θ (θ □ Θₙ) in the document block bₙ appears in the media block vₖ is set to a keyword appearance frequency β_{k, n, θ} (S34), and the media analysis server 7 shifts to the process S29. On the other hand, when the character analysis is not conducted (No in S31), the flow is ended.

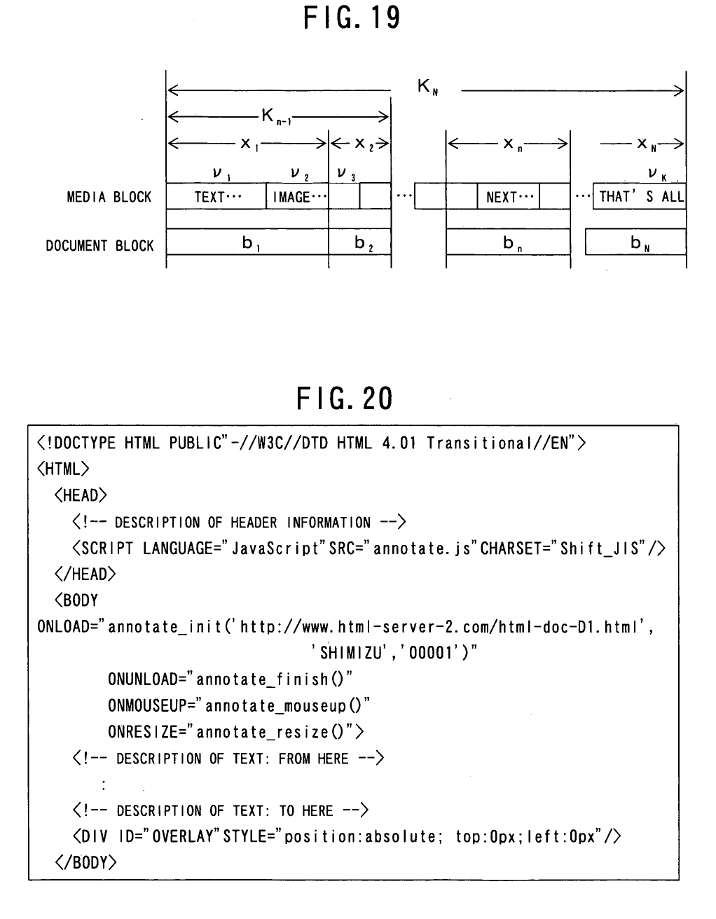

Then, the media analysis server 7 associates the document block bₙ with the media block vₖ (S29). Corresponding information is generated by distributing the K pieces of the media blocks vₖ to N pieces of the document blocks bₙ by xₙ pieces from the beginning. This relation is shown in FIG. 19. Further, the accuracy of the distribution is represented by the following formula (1).

$$E ( {x}_{1} , {x}_{2} , ⩓ , {x}_{N} ) = {\sum }_{n = 1}^{N} {g}_{n} ( {k}_{n - 1} , {x}_{n} ) \qquad ( 1 )$$

At this time, the optimum distribution becomes a combination of {x₁, x₂, . . . , x_{N}} maximizing the value of E (x₁, x₂, . . . , x_{N}). Here, gn(kₙ₋₁, x_{N}) is a function representing the profit (accuracy of the distribution for each document block) for every document block obtained when Xₙ pieces that is continued from kₙ₋₁ of the media block is distributed to the document block bₙ, and is determined from a weight coefficient W_{n, θ}, and a keyword appearance frequency β_{k, n, θ}. Furthermore, {x₁, x₂, . . . , x_{N}} for maximizing the formula (1) can be obtained by a dynamic programming method. The playback starting time Sₙ of the segment corresponding to the document block bₙ is represented by the playback starting time of the initial media block distributed to the document block bₙ. Incidentally, the section including all the continuous sound sections in which the speech of the keyword of the document block bₙ is performed may be assigned to the segment. In this case, there is possibility that the sound section duplicated between the sites is assigned as the segment.

The media analysis server 7 describes the determined segment in a metafile shown in FIG. 16 (S30). Then, the generated metafile is uploaded to the media serer 6. Then, the URL of the metafile on the media server 6 is acquired. The annotation data shown in FIG. 17 is generated by using this URL, and registered with the database 5. Here, the keyword in the annotation data may be the keyword θ (θ □ Θₙ) in the document block bₙ. The foregoing description is the annotation data registration process in the case of the automatic segment specification.

Incidentally, in this embodiment, the URL-B described in the document list to access the selected HTML document as described above is represented in the form of delivering the URL of the HTML document in the document server 2 to the document transformation server 3, that is, by the URL-B (for example, http://www.trans-server-3.com/trans.cgi?url=http://www.html-server-2.com/ht ml-doc-D1.html). In this case, all the annotation data regarding the selected HTML document are displayed as labels by retrieving from the database 5. Here, when the selected HTML document is browsed, only the annotation data having the corresponding annotator name and the annotation ID may be displayed by specifying the annotator name and the annotation ID.

Here, the URL-C (for example, http://www.trans-server-3.com/trans.cgi?url=http://www.html-server-2.com/ht ml-doc-D1.html&annotator=shimizu&id=00001) for specifying the annotator name and the annotation ID is set to the link destination when the selected HTML document is browsed. This URL includes the annotator name and the annotation ID as the argument of CGI, trans.cgi operating in the document transformation server 3. The document transformation server 3 accessed by this URL generates the transformed THML document including the annotator name and the annotation ID as the argument of the “annotate-init” function of the attachment program. FIG. 20 shows an example of the transformation HTML document of this case.

Then, the browser 41 reads the annotation data having the annotator name and the annotation ID described in the transformed HTML document from the database 5 according to the attachment program, and displays in an overlaid manner the annotation data as labels on the selected HTML document. The annotation in the HTML document can be specified on an annotator basis and an annotation basis by representation using the URL. Further, this URL can be notified to other user by e-mail.

### INDUSTRIAL APPLICABILITY

According to the present invention as described above, the present invention can be utilized as a groupware for performing communication by adhering a comment, related AV data to a specific document, and a remote education system of a teacher and students who write questions to a teaching material page. Further, the voice data recorded in a conference is associated with the conference minutes, and hence the present invention can be utilized for an information sharing system for transmitting the atmosphere in the conference to the members who do not participate in the conference.

1. An annotation management system that manages annotation data of information regarding annotation of an electronic document comprising:
a client having a browser that conducts display of an electronic document, execution of an electronic document attachment program added to the electronic document and an acceptance of a user's input;
a document server that stores electronic documents;
a database that manages annotation data for every electronic document; and
a document transformation server that acquires a selected electronic document of the electronic document requested from the client from the document server, generates a transformed electronic document which an electronic document attachment program that conducts input and display of annotation data is attached to the selected electronic document, and delivers the transformed electronic document to the client.

2. The annotation management system according to claim 1, wherein
the annotation data includes an annotation content having a URL of a media file to become annotation or a text to become annotation, and a position for displaying a label based on the annotation data.

3. The annotation management system according to claim 2, wherein
the electronic document attachment program includes:
a document block specifying unit that divides the selected electronic document into document blocks so that a document block corresponding to the position specified by the user is set to a selected document block;
an annotation data inputting unit that inputs input data regarding the annotation data;
an annotation data generating unit that generates the annotation data corresponding to the selected document block based on the input data;
an annotation data registering unit that registers the annotation data generated by the annotation data generating unit with the database;
an annotation data acquiring unit that acquires the annotation data of the selected electronic document from the database,
a label display unit that displays, in a duplicate manner, labels based on the annotation data acquired by the annotation data acquiring unit on the selected electronic document; and
an annotation data display unit that displays the annotation data corresponding to the label specified by the user among the labels.

4. The annotation management system according to claim 3, wherein
the annotation content further contains a URL of a metafile describing a range that the media file is played back, or a metafile when the type of the annotation content is a video media file or an audio media file.

5. The annotation management system according to claim 4, further comprising:
a media server that manages the media file, wherein
the electronic document attachment program further includes an upload unit that uploads the media file to the media server when the media file is not opened.

6. The annotation management system according to claim 5, further comprising
a media analysis server having:
a document block dividing unit that divides the selected electronic document into document blocks;
a keyword extracting unit that extracts a keyword contained in the document blocks;
a document keyword appearance frequency detecting unit that detects the appearance frequency of the keyword in the document blocks;
a media block dividing unit that divides the media file into media blocks;
a voice recognizing unit that performs voice recognition of the keyword by using voice data in the media blocks;
a media keyword appearance frequency detecting unit that detects the appearance frequency of the keyword in the media blocks;
an association unit that associates the document blocks with the media blocks based on the appearance frequency of the keyword in the document blocks and the appearance frequency of the keyword in the media blocks;
a metafile generating unit that generates a metafile describing the range of the media file played back corresponding to the selected document block; and
an upload unit that uploads the metafile to the media server.

7. The annotation management system according to claim 5, further comprising
a media analysis server having:
a document block dividing unit that divides the selected electronic document into document blocks;
a keyword extracting unit that extracts a keyword contained in the document blocks;
a document keyword appearance frequency detecting unit that detects the appearance frequency of the keyword in the document blocks;
a media block dividing unit that divides the media file into media blocks;
a character recognizing unit that performs character recognition of the keyword by using dynamic image data in the media blocks;
a media keyword appearance frequency detecting unit that detects the appearance frequency of the keyword in the media blocks;
an association unit that associates the document blocks with the media blocks based on the appearance frequency of the keyword in the document blocks and the appearance frequency of the keyword in the media blocks;
a metafile generating unit that generates a metafile describing the range of the media file played back corresponding to the selected document block; and
an upload section that uploads the metafile to the media server.

8. The annotation management system according to claim 5, wherein
the electronic document attachment program further includes a metafile generating unit that determines the range that the media file is played back according to the user's input to generate a metafile for playing back the range.

9. The annotation management system according to claim 3, wherein
the electronic document attachment program further includes a keyword extracting unit that extracts a keyword contained in the selected document block, and
the annotation data further contains the keyword.

10. The annotation management system according to claim 9, wherein
the document transformation unit adds a tag representing the delimiter of the document blocks according to a predetermined rule to the transformed electronic document.

11. The annotation management system according to claim 3, wherein
the annotation data further contains an annotator name and an annotation ID, and
when the annotator name or the annotation ID is specified, the annotation data acquiring unit acquires only the annotation data in which the specified annotator name or the annotation ID coincides.

12. A document transformation server that acquires an electronic document stored in a server on a network, transforms the document and delivers the document to a client in the network, comprising:
a selected electronic document acquiring unit that acquires the selected electronic document of the electronic document requested from the client from a document server;
a transformed electronic document generating unit that generates a transformed electronic document which the electronic document attachment program for inputting and displaying annotation data is attached to the selected electronic document; and
a transformed electronic document delivering unit that delivers the transformed electronic document to the client.

13. The document transformation server according to claim 12, wherein
the electronic document attachment program includes:
a document block specifying unit that divides the selected electronic document into document blocks so that a document block corresponding to the position specified by the user is set to a selected document block;
an annotation data input unit that inputs input data regarding the annotation data;
an annotation data generating unit that generates the annotation data corresponding to the selected document block based on the input data;
an annotation data registering unit that registers the annotation data generated by the annotation data generating unit with the database;
an annotation data acquiring unit that acquires the annotation data of the selected electronic document from the database;
a label display unit that displays, in a duplicate manner, labels based on the annotation data acquired by the annotation data acquiring unit on the selected electronic document; and
an annotation data display unit that displays the annotation data corresponding to a label specified by the user among the labels.

14. An annotation managing method that manages annotation data of information regarding the annotation of an electronic document, storing electronic documents;
managing annotation data for every electronic document;
acquiring the selected electronic document of the electronic document requested from the browser from a document server;
generating a transformed electronic document which the electronic document attachment program for inputting and reading annotation data is attached to the selected electronic document;
conducting display of the transformed electronic document, execution of the electronic document attachment program attached to the transformed electronic document and receiving inputs of the user;
generating annotation data according to the user's input; and
registering the annotation data.

15. An electronic document attachment program that is attached to the selected electronic document selected by the user and stored in a computer-readable medium in order to make a computer execute an electronic document attachment method for performing input and browse of the annotation data, the program comprising:
dividing the selected electronic document into document blocks and making a document block corresponding to the position specified by the user as the selected document block;
inputting input data regarding the annotation data;
generating the annotation data corresponding to the selected document block based on the input data;
registering the generated annotation data with the database;
acquiring the annotation data of the selected electronic document from the database;
displaying, in a duplicate manner, labels based on the annotation data on the selected electronic document; and
a displaying the annotation data corresponding to a label specified by the user among the labels.

16. A document transformation program stored in a computer-readable medium in order to make a computer execute a document transformation method that acquires and transforms an electronic document stored in a server on a network and delivers the document to the client on the network, the program comprising:
acquiring the selected electronic document of the electronic document requested from the client from a document server;
generating a transformed electronic document which the electronic document attachment program according to claim 15 is attached to the selected electronic document; and
delivering the transformed electronic document to the client.
